(19) United States
(12) Patent Application Publication
(10) Pub. No.: US 2024/0427271 A1
(43) Pub. Date: Dec. 26, 2024

(54) IMAGE FORMING APPARATUS

(71) Applicant: FUJIFILM Business Innovation Corp., Tokyo (JP)

(72) Inventors: Takashi ANZAI, Kanagawa (JP); Atsushi Kaneko, Kanagawa (JP); Toshio Takiguchi, Kanagawa (JP)

(73) Assignee: FUJIFILM Business Innovation Corp., Tokyo (JP)

(21) Appl. No.: 18/512,476

(22) Filed: Nov. 17, 2023

(30) Foreign Application Priority Data
Jun. 21, 2023 (JP) 2023-102051

(51) Int. Cl. G03G 15/00; G03G 15/08

(52) U.S. Cl. CPC G03G 15/5008; G03G 15/0808; G03G 2215/025; G03G 2215/066

(57) ABSTRACT

An image forming apparatus includes: an image carrier unit that is attachable to and removable from an apparatus body and that includes an image carrier; a development roller that passes toner to the image carrier when located in a position near the image carrier; an operation portion that moves, when operated, between a block position in which the operation portion blocks detachment of the image carrier unit from the apparatus body and an allowance position in which the operation portion allows detachment of the image carrier unit from the apparatus body, the development roller moving toward the image carrier in association with a movement of the operation portion to the block position, and the development roller moving away from the image carrier in association with a movement of the operation portion to the allowance position; and a positioning portion that positions the image carrier unit relative to the apparatus body in an attachment-removal direction of the image carrier unit when the operation portion is moved to the block position.

### CROSS-REFERENCE TO RELATED APPLICATIONS

This application is based on and claims priority under 35 USC 119 from Japanese Patent Application No. 2023-102051 filed Jun. 21, 2023.

### BACKGROUND

### (i) Technical Field

The present disclosure relates to an image forming apparatus.

### (ii) Related Art

A process cartridge described in Japanese Unexamined Patent Application Publication No. 2015-191070 includes an image carrier assembly inserted into and removed from a predetermined assembly receiver and including an image carrier that carries a latent image, a development assembly including a developer holder that holds a developer, an urging member that urges a development assembly to press a developer holder of the development assembly against both ends of the image carrier of the image carrier assembly in the longitudinal direction, a detachment mechanism disposed at a near side of the image carrier assembly in an insertion-removal direction, and that moves, when operated in a predetermined direction, the image carrier assembly and the development assembly away from each other against the urging force exerted by the urging member, and a gap defining mechanism that brings part of the image carrier assembly on a far side in the insertion-removal direction into contact with a guide portion disposed at the development assembly and extending in the insertion-removal direction when the image carrier assembly is pulled out in a pull-out direction while the development assembly is moved away from the image carrier assembly by the detachment mechanism, to form a larger gap on the far side between the image carrier and the developer holder than before the image carrier assembly is pulled out, against the urging force of the urging member.

### SUMMARY

An image forming apparatus includes an image carrier unit including an image carrier, and a development roller disposed near the image carrier. This image carrier unit is attachable to and removable from an apparatus body.

In this structure, the development roller disposed near the image carrier is moved away from the image carrier, and then the image carrier unit is detached from the apparatus body. More specifically, when an operation portion disposed in a block position in which it blocks detachment of the image carrier unit is moved to an allowance position in which it allows detachment of the image carrier unit, the development roller that has moved toward the image carrier is moved away from the image carrier in association with this movement.

Separate from the operation portion, a positioning portion is disposed. While the image carrier unit is attached to the apparatus body, the positioning portion positions the image carrier unit relative to the apparatus body in an attachment-removal direction of attaching or removing the image carrier unit. By operating the positioning portion independently from the operation portion, the image carrier unit is positioned relative to the apparatus body.

Aspects of non-limiting embodiments of the present disclosure relate to positioning of the image carrier unit relative to the apparatus body without independently operating the positioning portion in a structure where the development roller is moved toward or away from the image carrier in association with the operation on the operation portion that stops or allows detachment of the image carrier unit.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus that includes: an image carrier unit that is attachable to and removable from an apparatus body and that includes an image carrier; a development roller that passes toner to the image carrier when located in a position near the image carrier; an operation portion that moves, when operated, between a block position in which the operation portion blocks detachment of the image carrier unit from the apparatus body and an allowance position in which the operation portion allows detachment of the image carrier unit from the apparatus body, the development roller moving toward the image carrier in association with a movement of the operation portion to the block position, and the development roller moving away from the image carrier in association with a movement of the operation portion to the allowance position; and a positioning portion that positions the image carrier unit relative to the apparatus body in an attachment-removal direction of the image carrier unit when the operation portion is moved to the block position.

### BRIEF DESCRIPTION OF THE DRAWINGS

Exemplary embodiments of the present disclosure will be described in detail based on the following figures, wherein:

FIG. 1 is a schematic diagram of an image forming apparatus according to an exemplary embodiment of the present disclosure;

FIG. 2 is a diagram of, for example, an image carrier unit and a development unit included in an image forming apparatus according to an exemplary embodiment of the present disclosure;

FIG. 3 is a diagram of, for example, an image carrier unit and a development unit included in an image forming apparatus according to an exemplary embodiment of the present disclosure;

FIG. 4 is a perspective view of, for example, an image carrier unit and a development unit included in an image forming apparatus according to an exemplary embodiment of the present disclosure;

FIG. 5 is a perspective view of, for example, an image carrier unit and a development unit included in an image forming apparatus according to an exemplary embodiment of the present disclosure;

FIGS. 6A and 6B are perspective views of a positioning structure of an image carrier unit included in an image forming apparatus according to an exemplary embodiment of the present disclosure;

FIG. 7 is an enlarged perspective view of a portion of a positioning structure of an image carrier unit included in an image forming apparatus according to an exemplary embodiment of the present disclosure; and

FIG. 8 is an enlarged perspective view of a portion of a positioning structure of an image carrier unit included in an image forming apparatus according to an exemplary embodiment of the present disclosure.

### DETAILED DESCRIPTION

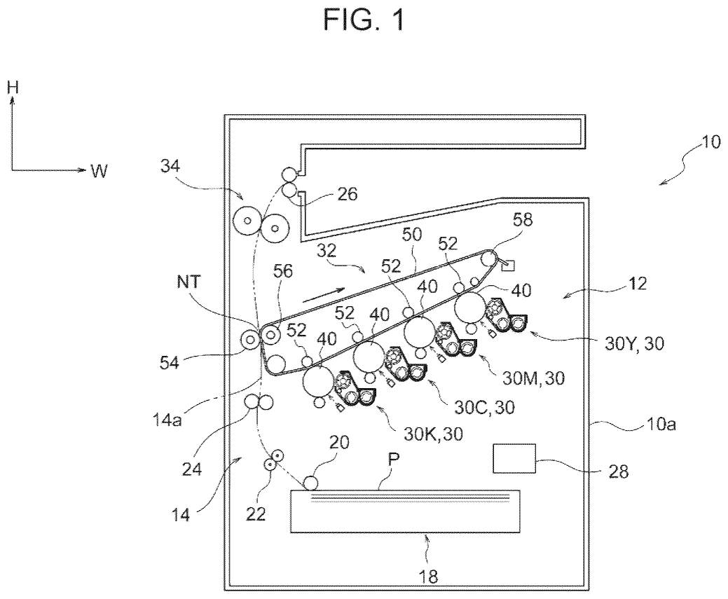

With reference to FIG. 1 to FIG. 8, an image forming apparatus according to an exemplary embodiment of the present disclosure is described. In the drawings, an arrow H denotes the apparatus height direction (the vertical direction), an arrow W denotes the apparatus width direction (the horizontal direction), and an arrow D denotes the apparatus depth direction (the horizontal direction).

### Entire Structure of Image Forming Apparatus 10

As illustrated in FIG. 1, an image forming apparatus 10 includes an image forming portion 12 that forms toner images through an electrophotographic system, and a transport portion 14 that transports sheet members P serving as recording media along a transport path 14a. The image forming apparatus 10 includes a container member 18 that accommodates the sheet members P, and a controller 28 that controls the entire apparatus.

In the image forming apparatus 10 with this structure, the transport portion 14 transports the sheet members P accommodated in the container member 18 along the transport path 14a. Then, toner images formed by the image forming portion 12 are formed on the sheet members P, and the sheet members P on which the toner images are formed are discharged to the outside from an apparatus body 10a.

### Image Forming Portion 12

As illustrated in FIG. 1, the image forming portion 12 includes multiple toner image forming portions 30 each forming toner images of a different color, and a transfer portion 32 that transfers the toner images formed by the toner image forming portions 30 to the sheet members P. The image forming portion 12 also includes a fixing device 34 that fixes the toner images transferred to the sheet members P by the transfer portion 32 to the sheet members P.

### Toner Image Forming Portions 30

The multiple toner image forming portions 30 each form toner images of a different color. In the present exemplary embodiment, the toner image forming portions 30 include toner image forming portions 30Y, 30M, 30C, and 30K for four colors of yellow (Y), magenta (M), cyan (C), and black (K). In the following description, Y, M, C, and K appended to the reference signs are omitted when the colors of yellow (Y), magenta (M), cyan (C), and black (K) are not to be distinguished from each other.

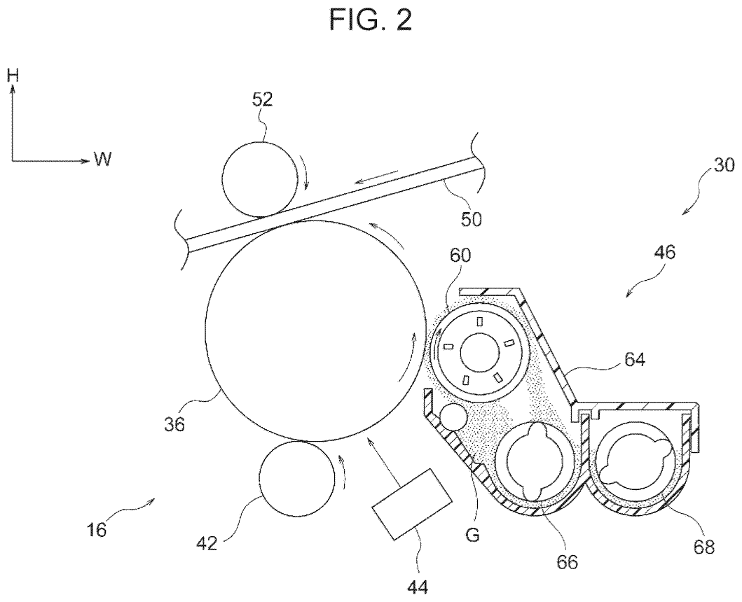

The toner image forming portions 30 for different colors have basically the same structure except for using different toner. As illustrated in FIG. 2, each toner image forming portion 30 includes an image carrier unit 16 including a rotatable cylindrical image carrier 36 and a charging device 42 that charges the image carrier 36 with electricity. Each toner image forming portion 30 includes an exposure device 44 that irradiates the charged image carrier 36 with exposure light to form electrostatic latent images, and a developing device 46 that develops the electrostatic latent images with a developer G containing toner into toner images. Thus, the toner image forming portions 30 for different colors form images of the different colors with toner of the different colors.

As illustrated in FIG. 1, the image carrier 36 for each color is in contact to a transfer belt 50 (described in detail below) that rotates. The toner image forming portions 30 for yellow (Y), magenta (M), cyan (C), and black (K) are arranged in this order from the upstream side in the rotation direction (indicated with an arrow in the drawing) of the transfer belt 50.

### Transfer Portion 32

As illustrated in FIG. 1, the transfer portion 32 includes the transfer belt 50, and first transfer rollers 52 each disposed opposite the image carrier 36 of the corresponding color with the transfer belt 50 interposed therebetween to transfer toner images formed on the image carrier 36 to the transfer belt 50.

The transfer portion 32 includes a winding roller 56 around which the transfer belt 50 is wound, and a driving roller 58 around which the transfer belt 50 is wound and that transmits a rotational force to the transfer belt 50. Thus, the transfer belt 50 rotates in the arrow direction in the drawing.

The transfer portion 32 also includes a second transfer roller 54 disposed opposite the winding roller 56 with the transfer belt 50 interposed therebetween and that transfers toner images transferred to the transfer belt 50 to the sheet members P. Between the second transfer roller 54 and the transfer belt 50, a transfer nip NT that transfers the toner images to the sheet members P is formed.

In this structure, in order of yellow (Y), magenta (M), cyan (C), and black (K), toner images are first-transferred to the transfer belt 50 by the first transfer rollers 52. In addition, the second transfer roller 54 transfers the toner images from the transfer belt 50 to the sheet members P transported while being held between the transfer belt 50 and the second transfer roller 54. In addition, the sheet members P to which the toner images are transferred are transported toward the fixing device 34.

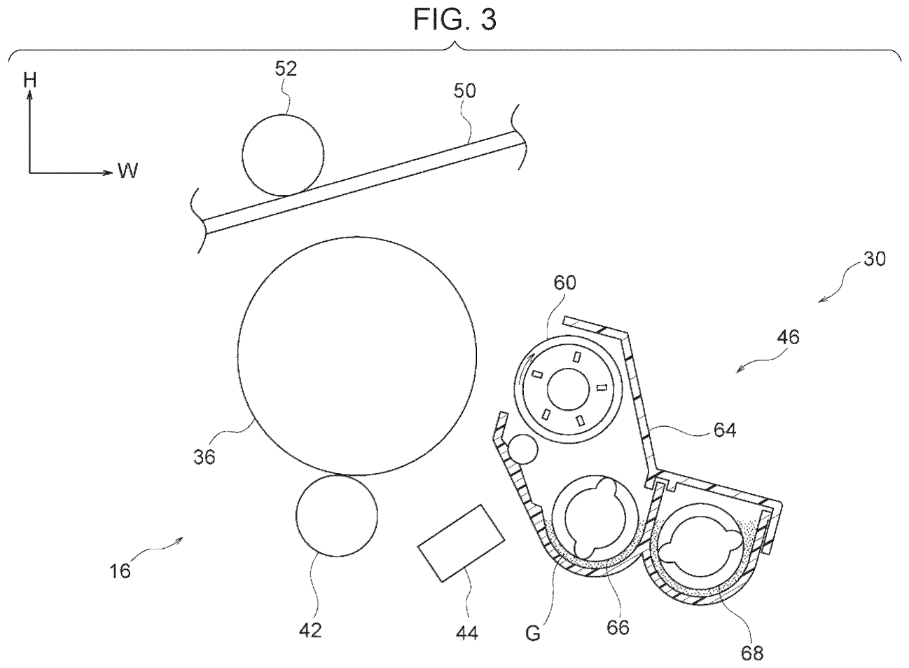

When a retract lever not illustrated is operated to, for example, remove jammed sheets, the first transfer rollers 52 and the transfer belt 50 are moved, and the transfer belt 50 is moved away from the image carrier 36 as illustrated in FIG. 3.

### Fixing Device 34

As illustrated in FIG. 1, the fixing device 34 is disposed downstream from the transfer nip NT in the transport direction of the sheet members P. The fixing device 34 heats and presses the toner images transferred to the sheet members P to fix the toner images to the sheet members P.

### Transport Portion 14

As illustrated in FIG. 1, the transport portion 14 includes a dispatch roller 20 that dispatches the sheet members P accommodated in the container member 18 to the transport path 14a, and stop rollers 22 that block transport of the sheet members P dispatched by the dispatch roller 20 in an overlapping manner. The transport portion 14 also includes adjustment rollers 24 that adjust the timing at which the sheet members P are dispatched to the transfer nip NT, and discharging rollers 26 that discharge the sheet members P to which the toner images are fixed by the fixing device 34 to the outside from the apparatus body 10a.

### Structure of Related Portion

Subsequently, components such as the developing device 46 and the image carrier unit 16 are described.

### Developing Device 46

As illustrated in FIG. 2, the developing device 46 includes a housing 64, a development roller 60 disposed opposite the image carrier 36, a supply auger 66 that supplies the developer G to the development roller 60, and an agitation auger 68 that agitates the developer G.

The developing device 46 is supported by the apparatus body 10a while being movable between a nearby position (refer to FIG. 2) in which the development roller 60 is disposed near the image carrier 36 and a far position (refer to FIG. 3) in which the development roller 60 is disposed away from the image carrier 36. When the development roller 60 passes toner to the image carrier 36 on which the electrostatic latent image is formed while the development roller 60 is in the nearby position, the electrostatic latent image is developed into a toner image.

### Image Carrier Unit 16

The image carrier unit 16 illustrated in FIG. 2 is supported by the apparatus body 10a to be attachable to and removable from the apparatus body 10a by being moved in the apparatus depth direction.

More specifically, the apparatus body 10a includes a covering, not illustrated, that covers the toner image forming portions 30 from the near side in the apparatus depth direction. While the covering is opened to expose the toner image forming portions 30, each image carrier unit 16 is attached to and removed from the apparatus body 10a.

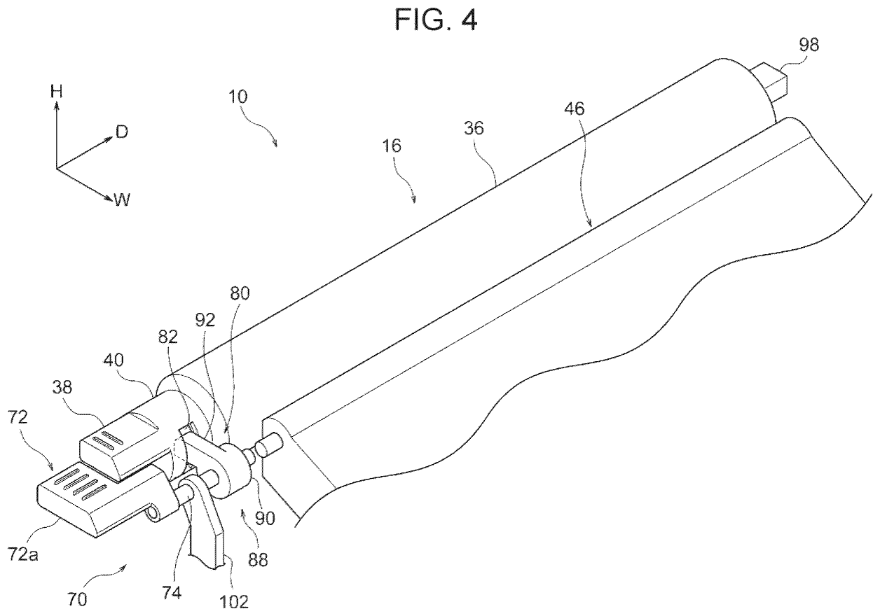

As illustrated in FIG. 4, the image carrier unit 16 includes a handle 38 to be held by an operator to attach or detach the image carrier unit 16 to or from the apparatus body 10a. The handle 38 is disposed on the image carrier 36 on the near side in the apparatus depth direction. Between the handle 38 and the image carrier 36 in the apparatus depth direction, a cylindrical portion 40 having an axis in the apparatus depth direction is disposed. Thus, the handle 38 is attached to the image carrier 36 with the cylindrical portion 40 interposed therebetween.

The handle 38 has a planar shape having surfaces facing in the vertical direction, and has a rectangular shape extending in the apparatus depth direction when viewed from above. On the upper surface of the handle 38, multiple protrusions (not denoted with reference signs) extending in the apparatus width direction are arranged side by side in the apparatus depth direction.

### Others

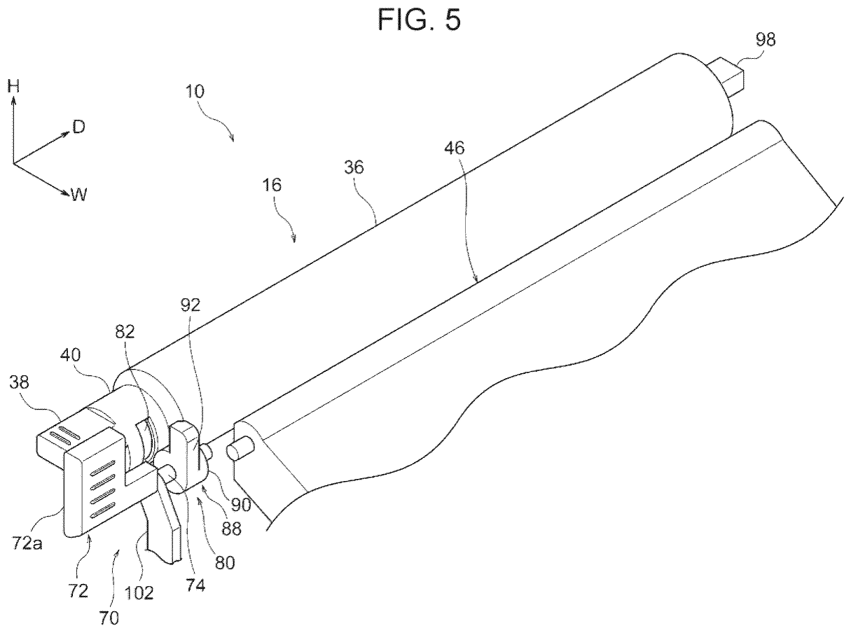

As illustrated in FIG. 4, the developing device 46 includes an operation portion 70 that moves, when operated, between a block position (refer to FIG. 4) in which it blocks detachment of the image carrier unit 16 and an allowance position (refer to FIG. 5) in which it allows detachment of the image carrier unit 16. When the operation portion 70 is moved to the block position, the development roller 60 is disposed nearer the image carrier 36 (refer to FIG. 2), and when the operation portion 70 is moved to the allowance position, the development roller 60 is disposed away from the image carrier (refer to FIG. 3).

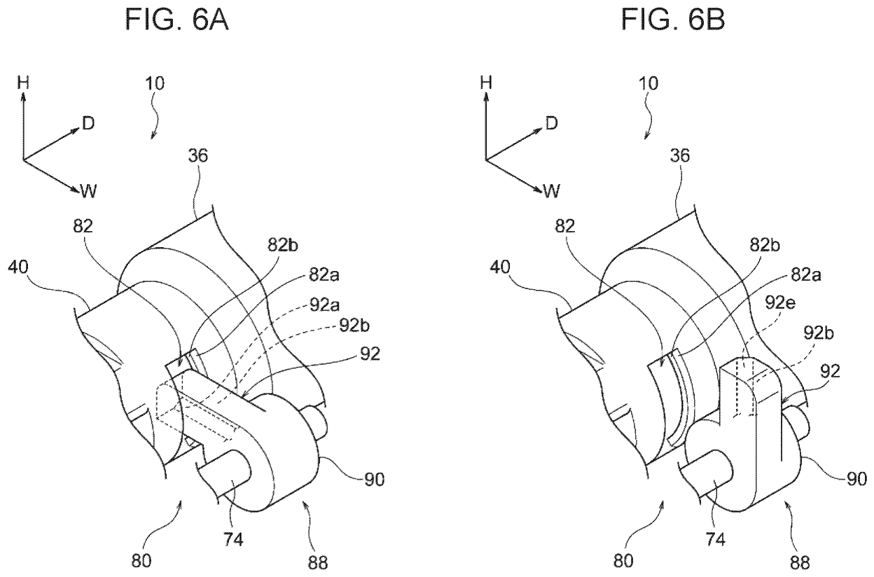

In addition, as illustrated in FIGS. 6A and 6B, the image forming apparatus 10 includes a positioning portion 80 that positions the image carrier unit 16 relative to the apparatus body 10a in the attachment-removal direction (in the apparatus depth direction in the exemplary embodiment) of the image carrier unit 16.

### Operation Portion 70

As illustrated in FIG. 4, the operation portion 70 is disposed on a near side of the developing device 46 in the apparatus depth direction, and includes a gripper member 72 to be held by an operator, and a shaft member 74 that rotatably supports the gripper member 72.

The shaft member 74 is cylindrical, extends in the apparatus depth direction, and is rotatably supported by a support member 102 attached to a frame not illustrated. More specifically, when viewed in the apparatus depth direction, the shaft member 74 is disposed on one side of the image carrier 36 in the apparatus width direction, and is disposed away from the image carrier unit 16. The gripper member 72 is attached to the shaft member 74 on the near side in the apparatus depth direction.

The gripper member 72 includes a block portion 72a disposed on the near side of the handle 38 in the apparatus depth direction while the operation portion 70 is located in the block position. While the operation portion 70 is located in the block position, the block portion 72a has a planar shape having plate surfaces facing in the vertical direction, and has a rectangular shape extending in the apparatus width direction when viewed from above. On the upper surface of the block portion 72a, multiple protrusions (not denoted with reference signs) extending in the apparatus depth direction are arranged side by side in the apparatus width direction.

At a protrusion 88 in the positioning portion 80, a cam member not illustrated is disposed, and a contact portion, not illustrated, of the developing device 46 is urged against the peripheral surface of the cam member. Thus, in association with the movement of the operation portion 70, the developing device 46 moves between the nearby position (refer to FIG. 2) in which the development roller 60 is disposed near the image carrier 36 and the far position (refer to FIG. 3) in which the development roller 60 is disposed away from the image carrier 36.

More specifically, the housing 64 of the developing device 46 extends in the apparatus depth direction, and is rotatably supported about the shaft member, not illustrated, disposed at the developing device 46. In association with the movement of the operation portion 70, the housing 64 of the developing device 46 rotates about the shaft member not illustrated with the cam member interposed therebetween, and the developing device 46 moves between the nearby position (refer to FIG. 2) in which the development roller 60 is disposed near the image carrier 36 and the far position (refer to FIG. 3) in which the development roller 60 is disposed away from the image carrier 36.

In this structure, the operation portion 70 is restricted to a rotation range by a stopper not illustrated, and moves between the block position (refer to FIG. 4) in which it blocks detachment of the image carrier unit 16 and the allowance position (refer to FIG. 5) in which it allows detachment of the image carrier unit 16.

More specifically, in the state where the gripper member 72 is moved to the block position, as illustrated in FIG. 4, the block portion 72a of the operation portion 70 overlaps the handle 38 in the image carrier unit 16 when viewed in the apparatus depth direction, and disposed on the near side of the handle 38 in the apparatus depth direction. Thus, the operation portion 70 that is moved to the block position blocks detachment of the image carrier unit 16. In association with the movement of the operation portion 70 to the block position, the developing device 46 is moved to the nearby position.

In contrast, in the state where the operation portion 70 is moved to the allowance position, as illustrated in FIG. 5, the gripper member 72 is disposed away from the image carrier unit 16 when viewed in the apparatus depth direction. Thus, the operation portion 70 moved to the allowance position allows detachment of the image carrier unit 16 to the near side in the apparatus depth direction. In association with the movement of the operation portion 70 to the allowance position, the developing device 46 is moved to the far position.

### Positioning Portion 80

As illustrated in FIG. 4 and FIG. 5, the positioning portion 80 includes a recess 82 formed in the cylindrical portion 40 of the image carrier unit 16, and the protrusion 88 insertable into and removable from the recess 82 and movable in association with the operation portion 70.

As illustrated in FIGS. 6A and 6B, the recess 82 is open toward the shaft member 74 in the apparatus width direction. In other words, the recess 82 is set back in the apparatus width direction. The apparatus width direction is an example of a cross direction.

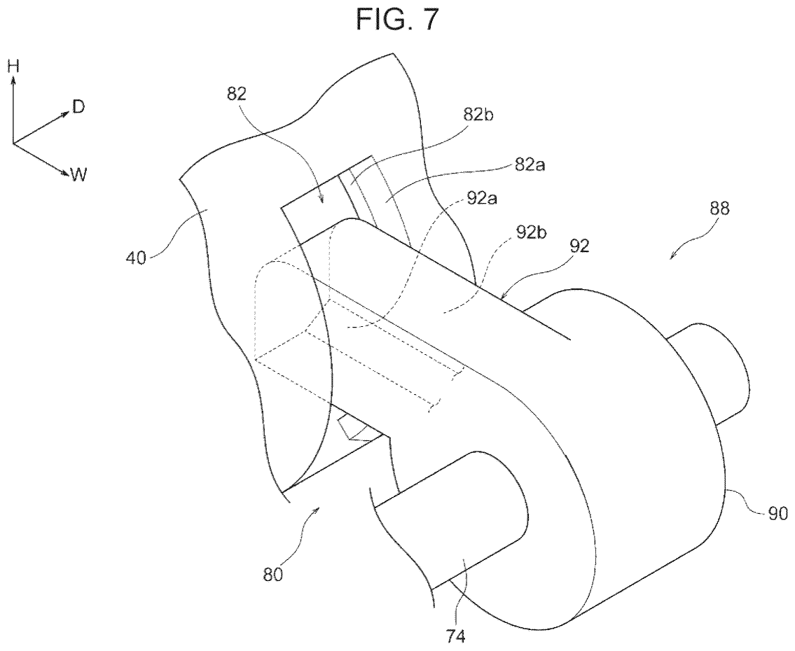

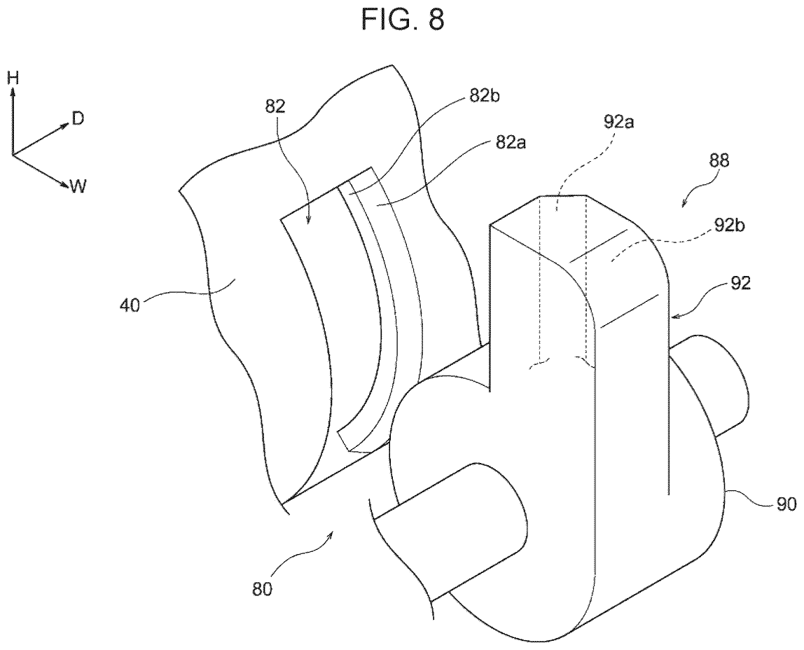

As illustrated in FIG. 7 and FIG. 8, the recess 82 extends in the circumferential direction of the cylindrical portion 40. The recess 82 has a guide surface 82a and a far end surface 82b. The guide surface 82a guides the protrusion 88 to the recess 82 during insertion of the protrusion 88 into the recess 82. The far end surface 82b faces the near side in the apparatus depth direction.

The guide surface 82a of the recess 82 is disposed at the opening on the far side in the apparatus depth direction to extend in the circumferential direction of the cylindrical portion 40. The guide surface 82a is inclined with respect to the apparatus width direction to increase the opening width of the recess 82 in the apparatus depth direction. The far end surface 82b is disposed to be in contact with the edge of the guide surface 82a on the near side in the depth direction. The guide surface 82a is also inclined with respect to the radial direction of the cylindrical portion 40.

In contrast, as illustrated in FIGS. 6A and 6B, the protrusion 88 is attached to the shaft member 74 of the operation portion 70, and includes a base portion 90 that surrounds the shaft member 74, and a protruding portion 92 that protrudes from the base portion 90 in the radial direction of the shaft member 74. The protrusion 88 is an example of part of the positioning portion 80.

As illustrated in FIG. 7 and FIG. 8, the protruding portion 92 has a rectangular cross section. The protruding portion 92 has a guide surface 92a, which guides the protruding portion 92 to the recess 82 when the protruding portion 92 of the protrusion 88 is inserted into the recess 82, and a far end surface 92b, which faces the far side in the apparatus depth direction. The guide surface 92a is an example of another guide surface.

The guide surface 92a of the protruding portion 92 extends in the radial direction of the shaft member 74 at a portion on the far side in the apparatus depth direction, and is inclined with respect to the circumferential direction of the shaft member 74. The far end surface 92b is disposed to come into contact with the edge of the guide surface 92a on the far side in the depth direction.

The image forming apparatus 10 includes an urging member 98 (refer to FIG. 4 and FIG. 5). When the operation portion 70 in the allowance position is moved to the block position while the image carrier unit 16 is attached to the apparatus body 10a, the urging member 98 urges the image carrier unit 16 to bring the guide surface 82a of the recess 82 into contact with the guide surface 92a of the protruding portion 92.

In this structure, as illustrated in FIG. 5, while the operation portion 70 is disposed in the allowance position, the image carrier unit 16 detached from the apparatus body 10a is moved to the far side in the apparatus depth direction to be attached to the apparatus body 10a. In this state, positioning of the image carrier unit 16 relative to the apparatus body 10a is cancelled. As illustrated in FIG. 4, the operation portion 70 in the allowance position is rotated to the block position.

When the operation portion 70 in the allowance position is rotated to the block position, the guide surface 92a of the protruding portion 92 of the protrusion 88 in the positioning portion 80 illustrated in FIG. 7 and FIG. 8 comes into contact with the guide surface 82a of the recess 82. More specifically, with the urging force of the urging member 98 (refer to FIG. 4), the image carrier unit 16 is urged to the near side in the apparatus depth direction, and the guide surface 82a of the recess 82 comes into contact with the guide surface 92a of the protruding portion 92. In this manner, the protrusion 88 is rotated while the guide surface 82a and the guide surface 92a come into contact with each other, and thus the protrusion 88 is guided to and inserted into the recess 82 (refer to FIG. 7).

In the state where the protrusion 88 is inserted into the recess 82, the image carrier unit 16 is urged to the near side in the apparatus depth direction by the urging force of the urging member 98, and the far end surface 82b of the recess 82 comes into contact with the far end surface 92b of the protruding portion 92 of the protrusion 88 (refer to FIG. 7). In this manner, the image carrier unit 16 is positioned relative to the apparatus body 10a in the apparatus depth direction.

When the operation portion 70 in the block position is rotated to the allowance position, the protruding portion 92 of the protrusion 88 illustrated in FIG. 7 and FIG. 8 is removed from the recess 82, and positioning of the image carrier unit 16 relative to the apparatus body 10a is cancelled.

In this manner, the protrusion 88 in the positioning portion 80 is inserted into or removed from the recess 82 with transmission of the moving force of the operation portion 70. The moving force is an operating force caused by operating the operation portion 70 to move the protrusion 88.

### Summarization

As described above, in the image forming apparatus 10, while the image carrier unit 16 is attached to the apparatus body 10a and the operation portion 70 is disposed in the allowance position, as illustrated in FIG. 3, the development roller 60 is disposed in the far position in which it is disposed away from the image carrier 36. When the operation portion 70 in the allowance position is rotated to the block position, as illustrated in FIG. 2, the development roller 60 is moved to the nearby position in which it is disposed near the image carrier 36. As illustrated in FIG. 4, the block portion 72a of the gripper member 72 in the operation portion 70 is disposed on the near side of the handle 38 in the image carrier unit 16 in the apparatus depth direction. This structure blocks a movement of the image carrier unit 16 to the near side in the apparatus depth direction and detachment of the image carrier unit 16 from the apparatus body 10a. In association with the rotation of the operation portion 70, the protrusion 88 in the positioning portion 80 is rotated, and the protruding portion 92 of the protrusion 88 is inserted into the recess 82. Thus, the image carrier unit 16 is positioned relative to the apparatus body 10a in the apparatus depth direction.

In the structure where the development roller 60 is moved toward and away from the image carrier 36 in association with the operation on the operation portion 70 that blocks or allows detachment of the image carrier unit 16, the image carrier unit 16 is positioned relative to the apparatus body 10a without independently operating the positioning portion 80.

In the image forming apparatus 10, when the operation portion 70 in the block position is rotated to the allowance position, as illustrated in FIG. 5, the protruding portion 92 of the protrusion 88 in the positioning portion 80 is removed from the recess 82, and positioning of the image carrier unit 16 relative to the apparatus body 10a is cancelled. In this manner, positioning of the image carrier unit 16 is cancelled without independently operating the positioning portion.

In the image forming apparatus 10, the protrusion 88 in the positioning portion 80 is inserted into and removed from the recess 82 with transmission of the moving force of the operation portion 70. In other words, with transmission of the moving force of the operation portion 70, the positioning portion 80 positions the image carrier unit 16 relative to the apparatus body 10a, or cancels the positioning of the image carrier unit 16 relative to the apparatus body 10a. In this manner, the positioning portion 80 is activated without operating an actuator with electricity.

In the image forming apparatus 10, the operation portion 70 includes the gripper member 72 to be held by an operator, and the shaft member 74 that rotatably supports the gripper member 72. The protrusion 88 in the positioning portion 80 is attached to the shaft member 74. The protrusion 88 rotates with the rotational force of the shaft member 74 to be inserted into and removed from the recess 82. Thus, the mechanism of transmitting the moving force has a simpler structure than a structure that uses a link to transmit the moving force of the operation portion to the positioning portion.

In the image forming apparatus 10, the positioning portion 80 includes the recess 82 set back in the apparatus width direction, which is a cross direction crossing the apparatus depth direction or the attachment-removal direction of the image carrier unit 16, and the protruding portion 92 of the protrusion 88 insertable into and removable from the recess 82 and movable in association with the operation portion 70. The recess 82 and the protrusion 88 are disposed in the image carrier unit 16 on the near side in the apparatus depth direction. In other words, the recess 82 and the protrusion 88 are disposed in the image carrier unit 16 on the removal side in the attachment-removal direction. As described above, the recess 82 and the protrusion 88 are disposed at a portion on the nearer side in the apparatus depth direction than in the case where the image carrier unit is positioned by fitting the protrusion and the recess set back in the apparatus depth direction or the attachment-removal direction of the image carrier unit to each other.

In the image forming apparatus 10, the protruding portion 92 of the protrusion 88 in the positioning portion 80 has the guide surface 92a that guides the protruding portion 92 to the recess 82 during insertion of the protruding portion 92 into the recess 82. In addition, the recess 82 in the positioning portion 80 has the guide surface 82a that is inclined with respect to the apparatus width direction, that may come into contact with the guide surface 92a, and that guides the protruding portion 92 of the protrusion 88 to the recess 82 during insertion of the protruding portion 92 into the recess 82. Thus, the protruding portion 92 of the protrusion 88 is more easily inserted into the recess 82 than when the recess has a rectangular cross section and the protruding portion has a rectangular cross section.

The image forming apparatus 10 includes the urging member 98 that urges the image carrier unit 16 to bring the guide surface 82a of the recess 82 into contact with the guide surface 92a of the protruding portion 92 during insertion of the protruding portion 92 of the protrusion 88 in the positioning portion 80 into the recess 82. Thus, the protruding portion 92 of the protrusion 88 is more smoothly inserted into the recess 82 than in the case where the guide surface 82a wobbles relative to the guide surface 92a.

The image forming apparatus 10 includes the urging member 98 that urges the image carrier unit 16 and brings the far end surface 82b of the recess 82 into contact with the far end surface 92b of the protruding portion 92 when the protruding portion 92 of the protrusion 88 in the positioning portion 80 is inserted into the recess 82. Thus, compared to the case where the protrusion inserted into the recess wobbles relative to the recess, this structure improves positioning accuracy of the image carrier unit 16 relative to the apparatus body 10a.

The present disclosure is described in detail based on a specific exemplary embodiment. However, it is apparent to those skilled in the art that the present disclosure is not limited to the exemplary embodiment, and may employ various other exemplary embodiments within the scope of the present disclosure. For example, in the exemplary embodiment, with transmission of the moving force of the operation portion 70, the positioning portion 80 positions the image carrier unit 16 relative to the apparatus body 10a or cancels the positioning of the image carrier unit 16 relative to the apparatus body 10a. Instead, for example, the positioning portion may be activated by operating an actuator with electricity in association with rotation of the operation portion. This structure has no effect caused by the positioning portion 80 being activated with the moving force of the operation portion 70.

In the above exemplary embodiment, the protrusion 88 included in the positioning portion 80 is attached to the shaft member 74, and is inserted into and removed from the recess 82 with transmission of the rotational force of the rotating shaft member 74. Instead, the moving force of the operation portion 70 may be transmitted to the protrusion 88 using, for example, a link. This structure has no effect caused by the protrusion 88 being inserted into and removed from the recess 82 with transmission of the rotational force of the rotating shaft member 74.

In the above exemplary embodiment, the protruding portion 92 of the protrusion 88 in the positioning portion 80 has the guide surface 92a, and the recess 82 has the guide surface 82a. Instead, for example, the recess may have a rectangular cross section, or the protruding portion may have a rectangular cross section. At least one of the recess or the protruding portion may have a rectangular cross section. This structure has no effect caused by the protrusion 88 and the recess 82 each having a guide surface.

In the above exemplary embodiment, the urging member 98 urges the image carrier unit 16 to the near side in the apparatus depth direction. Instead, a restriction member that restricts the range of movement of the image carrier unit 16 in the apparatus depth direction while the urging member 98 urges the image carrier unit 16 may be provided. More specifically, when a restriction member restricts the range of movement of the image carrier unit 16 to bring the guide surface 82a and the guide surface 92a into contact with each other, the guide surface 92a effectively comes into contact with the guide surface 82a.

In the above exemplary embodiment, the recess 82 in the positioning portion 80 is formed in the image carrier unit 16, and the protrusion 88 is attached to the shaft member 74. Instead, the protrusion may be attached to the image carrier unit, and the recess may be formed in the shaft member.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) An image forming apparatus comprising:
an image carrier unit that is attachable to and removable from an apparatus body and that includes an image carrier;
a development roller that passes toner to the image carrier when located in a position near the image carrier;
an operation portion that moves, when operated, between a block position in which the operation portion blocks detachment of the image carrier unit from the apparatus body and an allowance position in which the operation portion allows detachment of the image carrier unit from the apparatus body, the development roller moving toward the image carrier in association with a movement of the operation portion to the block position, the development roller moving away from the image carrier in association with a movement of the operation portion to the allowance position; and
a positioning portion that positions the image carrier unit relative to the apparatus body in an attachment-removal direction of the image carrier unit when the operation portion is moved to the block position.

(((2))) The image forming apparatus according to (((1))),
wherein, when the operation portion is moved to the allowance position, the positioning portion cancels positioning of the image carrier unit relative to the apparatus body.

(((3))) The image forming apparatus according to (((2))),
wherein the positioning portion positions the image carrier unit relative to the apparatus body and cancels positioning of the image carrier unit relative to the apparatus body with direct or indirect transmission of a moving force of the operation portion.

(((4))) The image forming apparatus according to (((3))),
wherein the operation portion includes a gripper member to be held by an operator and a shaft member that rotatably supports the gripper member, and
wherein part of the positioning portion is directly attached to the shaft member.

(((5))) The image forming apparatus according to any one of (((1))) to (((4))),
wherein the positioning portion includes a recess formed in the image carrier unit and set back in a cross direction that crosses the attachment-removal direction of the image carrier unit, and a protrusion that moves together with the operation portion and that is inserted into and removed from the recess.

(((6))) The image forming apparatus according to (((5))),
wherein the operation portion includes a gripper member to be held by an operator and a shaft member that rotatably supports the gripper member and that extends in the attachment-removal direction,
wherein the protrusion is attached to the shaft member, and protrudes in a radial direction of the shaft member,
wherein the recess is recessed in the cross direction to allow the protrusion that rotates to be inserted into and removed from the recess,
wherein the recess has a first guide surface that guides the protrusion to the recess during insertion of the protrusion into the recess, the first guide surface being inclined with respect to the cross direction to increase an opening width of the recess, and
wherein the protrusion has a second guide surface that guides the protrusion to the recess and that is allowed to come into contact with the first guide surface during insertion of the protrusion into the recess, the second guide surface being inclined with respect to a circumferential direction of the shaft member.

What is claimed is:

1. An image forming apparatus comprising:
an image carrier unit that is attachable to and removable from an apparatus body and that includes an image carrier;
a development roller that passes toner to the image carrier when located in a position near the image carrier;
an operation portion that moves, when operated, between a block position in which the operation portion blocks detachment of the image carrier unit from the apparatus body and an allowance position in which the operation portion allows detachment of the image carrier unit from the apparatus body, the development roller moving toward the image carrier in association with a movement of the operation portion to the block position, the development roller moving away from the image carrier in association with a movement of the operation portion to the allowance position; and
a positioning portion that positions the image carrier unit relative to the apparatus body in an attachment-removal direction of the image carrier unit when the operation portion is moved to the block position.

2. The image forming apparatus according to claim 1,
wherein, when the operation portion is moved to the allowance position, the positioning portion cancels positioning of the image carrier unit relative to the apparatus body.

3. The image forming apparatus according to claim 2,
wherein the positioning portion positions the image carrier unit relative to the apparatus body and cancels positioning of the image carrier unit relative to the apparatus body with direct or indirect transmission of a moving force of the operation portion.

4. The image forming apparatus according to claim 3,
wherein the operation portion includes a gripper member to be held by an operator and a shaft member that rotatably supports the gripper member, and
wherein part of the positioning portion is directly attached to the shaft member.

5. The image forming apparatus according to claim 1,
wherein the positioning portion includes a recess formed in the image carrier unit and set back in a cross direction that crosses the attachment-removal direction of the image carrier unit, and a protrusion that moves together with the operation portion and that is inserted into and removed from the recess.

6. The image forming apparatus according to claim 5,
wherein the operation portion includes a gripper member to be held by an operator and a shaft member that rotatably supports the gripper member and that extends in the attachment-removal direction,
wherein the protrusion is attached to the shaft member, and protrudes in a radial direction of the shaft member,
wherein the recess is recessed in the cross direction to allow the protrusion that rotates to be inserted into and removed from the recess,
wherein the recess has a first guide surface that guides the protrusion to the recess during insertion of the protrusion into the recess, the first guide surface being inclined with respect to the cross direction to increase an opening width of the recess, and
wherein the protrusion has a second guide surface that guides the protrusion to the recess and that is allowed to come into contact with the first guide surface during insertion of the protrusion into the recess, the second guide surface being inclined with respect to a circumferential direction of the shaft member.

7. An image forming apparatus, comprising:
image carrier means for being attached to and removed from an apparatus body, and including an image carrier;
development roller means for passing toner to the image carrier when located in a position near the image carrier;
operation means for, when operated, moving between a block position in which the operation means blocks detachment of the image carrier means from the apparatus body and an allowance position in which the operation means allows detachment of the image carrier means from the apparatus body, the development roller means moving toward the image carrier in association with a movement of the operation means to the block position, and the development roller means moving away from the image carrier in association with a movement of the operation means to the allowance position; and
positioning means for positioning the image carrier means relative to the apparatus body in an attachment-removal direction of the image carrier means when the operation means is moved to the block position.
